(19) United States
(12) Patent Application Publication
(10) Pub. No.: US 2015/0116253 A1
(43) Pub. Date: Apr. 30, 2015

(54) GHOST SUPPRESSION USING HYBRID CAPACITIVE SENSING

(71) Applicant: Synaptics Incorporated, San Jose, CA (US)

(72) Inventor: Adam Schwartz, Redwood City, CA (US)

(73) Assignee: SYNAPTICS INCORPORATED, San Jose, CA (US)

(21) Appl. No.: 14/064,022

(22) Filed: Oct. 25, 2013

(51) Int. Cl. G06F 3/041; G06F 3/044; G01B 7/14

(52) U.S. Cl. CPC G06F 3/0418; G01B 7/14; G06F 3/044
USPC 345/174

(57) ABSTRACT

A processing system for a capacitive input device includes functionality to perform a trans capacitance measurement of an array of sensor electrodes, determine a presence of at least one input object in the sensing region from the trans capacitance measurement, perform an absolute capacitive measurement along a first axis of the array of sensor electrodes, and suppress the determined presence of at least one input object based on a lack of a correlated input object presence from the absolute capacitive measurement along the first axis. The capacitive input device includes the array of sensor electrodes configured to sense input objects in a sensing region of the input device.

### FIELD OF THE INVENTION

This invention generally relates to electronic devices.

### BACKGROUND

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

In general, in one aspect, embodiments relate to a processing system for a capacitive input device. The capacitive input device includes an array of sensor electrodes configured to sense input objects in a sensing region of the input device. The processing system includes functionality to perform a trans capacitance measurement of the array of sensor electrodes, determine a presence of at least one input object in the sensing region from the trans capacitance measurement, perform an absolute capacitive measurement along a first axis of the array of sensor electrodes, and suppress the determined presence of at least one input object based on a lack of a correlated input object presence from the absolute capacitive measurement along the first axis.

In general, in one aspect, embodiments relate to a method that includes performing a trans capacitance measurement of an array of sensor electrodes configured to sense input objects in a sensing region of the input device, determining a presence of at least one input object in the sensing region from the trans capacitance measurement, performing an absolute capacitive measurement along a first axis of the array of sensor electrodes, and suppressing the determined presence of at least one input object based on a lack of a correlated input object presence from the absolute capacitive measurement along the first axis.

In general, in one aspect, embodiments relate to an input device including an array of sensor electrodes configured to sense input objects in a sensing region of the input device, and a processing system. The processing system is configured to perform a trans capacitance measurement of the array of sensor electrodes, determine a presence of at least one input object in the sensing region from the trans capacitance measurement, perform an absolute capacitive measurement along a first axis of the array of sensor electrodes, and suppress the determined presence of at least one input object based on a lack of a correlated input object presence from the absolute capacitive measurement along the first axis.

Other aspects of the invention will be apparent from the following description and the appended claims.

### BRIEF DESCRIPTION OF DRAWINGS

The preferred exemplary embodiment of the present invention will hereinafter be described in conjunction with the appended drawings, where like designations denote like elements, and:

FIGS. 1-5 show schematic diagrams in accordance with one or more embodiments of the invention.

FIGS. 6, 7A, and 7B show flowcharts in accordance with one or more embodiments of the invention.

FIGS. 8 and 9 show an example in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to ghost finger detection and suppression. Specifically, in trans capacitance sensing, a sensing region is scanned either by rows or by columns. In other words, a processing system may locate where fingers are placed along the scanned axis by associating the measured signal with the time at which a particular row or column is scanned. If a burst of noise occurs at the time the particular row or column is scanned, the processing system may determine that a finger is located at the particular row or column even though the finger is actually located at a different row or column. In other words, the processing system may detect two fingers rather than a single finger. The incorrectly detected finger may be referred to as a ghost finger.

One or more embodiments of the invention detect that a finger is a ghost finger using absolute capacitance sensing. Specifically, in one or more embodiments of the invention, trans capacitance sensing of a sensing region may be performed to identify a location of one or more input objects. Further, absolute capacitance sensing of the sensing region may be performed to determine whether the one or more input objects identified using trans capacitance sensing are a ghost finger. The absolute capacitance sensing may be performed before, during, or after the trans capacitance sensing.

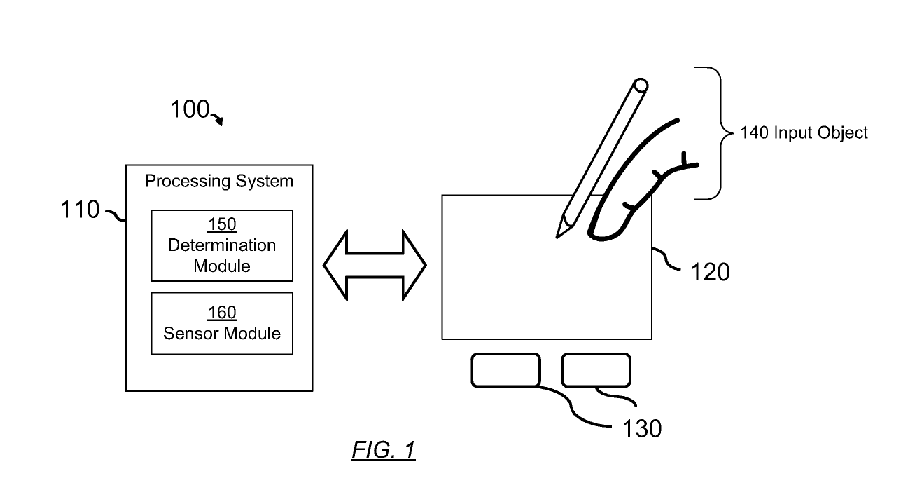

Turning now to the figures, FIG. 1 is a block diagram of an exemplary input device (100), in accordance with embodiments of the invention. The input device (100) may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device (100) and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device (100) may be implemented as a physical part of the electronic system, or may be physically separate from the electronic system. As appropriate, the input device (100) may communicate with parts of the electronic system using any one or more of the following: buses, networks, and other wired or wireless interconnections. Examples include I2C, SPI, PS/2, Universal Serial Bus (USB), Bluetooth, RF, and IRDA.

In FIG. 1, the input device (100) is shown as a proximity sensor device (also often referred to as a “touchpad”, “touch screen”, or a “touch sensor device”) configured to sense input provided by one or more input objects (140) in a sensing region (120). Example input objects include pen, stylus, fingers, and other objects that may be in the sensing region.

Sensing region (120) encompasses any space above, around, in and/or near the input device (100) in which the input device (100) is able to detect user input (e.g., user input provided by one or more input objects (140)). The sizes, shapes, and locations of particular sensing regions may vary widely from embodiment to embodiment. In some embodiments, the sensing region (120) extends from a surface of the input device (100) in one or more directions into space until signal-to-noise ratios prevent sufficiently accurate object detection. The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that includes no contact with any surfaces of the input device (100), contact with an input surface (e.g. a touch surface) of the input device (100), contact with an input surface of the input device (100) coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) includes one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device (100), a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device (100), one or more sensing elements pick up loop currents induced by a resonating coil or pair of coils. Some combination of the magnitude, phase, and frequency of the currents may then be used to determine positional information.

In some capacitive implementations of the input device (100), voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

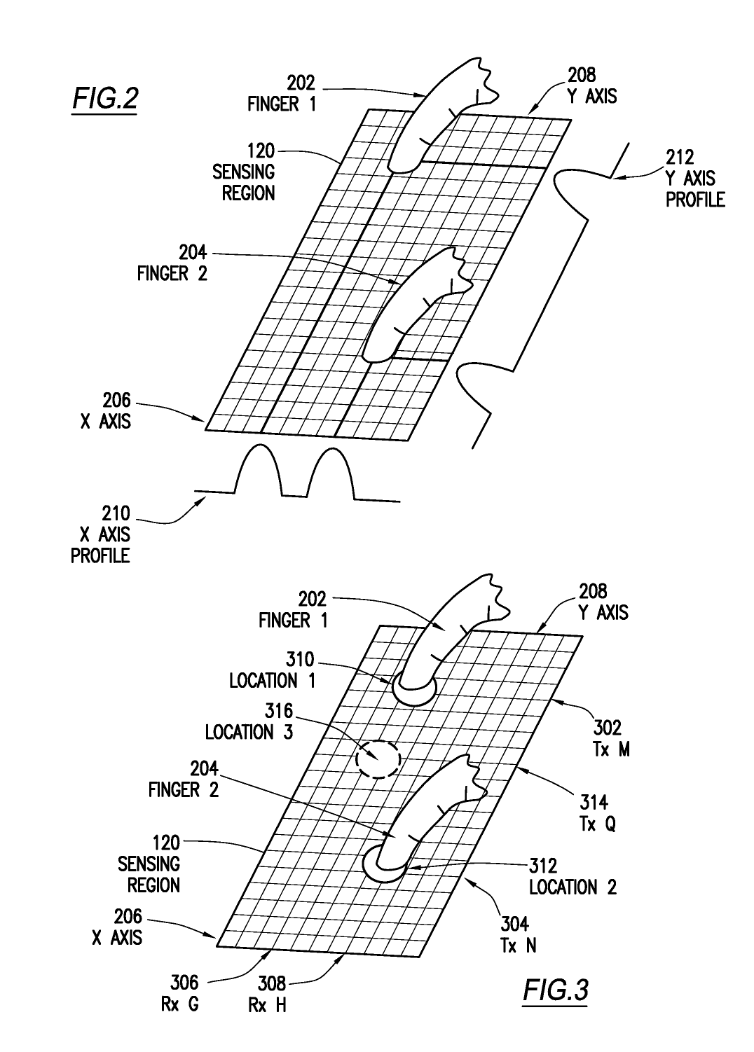

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects. An example of absolute capacitance sensing is shown in FIG. 2 below.

Some capacitive implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a trans capacitance sensing method operates by detecting the capacitive coupling between one or more transmitter sensor electrodes (also “transmitter electrodes”) and one or more receiver sensor electrodes (also “receiver electrodes”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may include effect(s) corresponding to one or more transmitter signals, and/or to one or more sources of environmental interference (e.g. other electromagnetic signals). Sensor electrodes may be dedicated transmitters or receivers, or may be configured to both transmit and receive. An example of trans capacitance sensing is shown in FIG. 3 below.

In some implementations, the input device uses a hybrid capacitance sensor. A hybrid capacitive sensor is capable of performing both trans capacitance sensing as well as absolute capacitance sensing.

Some optical techniques utilize optical sensing elements (e.g., optical transmitters and optical receivers). Such optical transmitters transmit optical transmitter signals. The optical receivers include functionality to receive resulting signals from the optical transmitter signals. A resulting signal may include effect(s) corresponding to one or more transmitter signals, one or more input objects (140) in the sensing region, and/or to one or more sources of environmental interference. For example, the optical transmitters may correspond to a light emitting diode (LED), organic LED (OLED), light bulb, or other optical transmitting component. In one or more embodiments, the optical transmitter signals are transmitted on the infrared spectrum.

In FIG. 1, a processing system (110) is shown as part of the input device (100). The processing system (110) is configured to operate the hardware of the input device (100) to detect input in the sensing region (120). The processing system (110) includes parts of or all of one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes). In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to sensing element(s) of input device (100), and one or more components elsewhere. For example, the input device (100) may be a peripheral coupled to a desktop computer, and the processing system (110) may include software configured to run on a central processing unit of the desktop computer and one or more ICs (perhaps with associated firmware) separate from the central processing unit. As another example, the input device (100) may be physically integrated in a phone, and the processing system (110) may include circuits and firmware that are part of a main processor of the phone. In some embodiments, the processing system (110) is dedicated to implementing the input device 100. In other embodiments, the processing system (110) also performs other functions, such as operating display screens, driving haptic actuators, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include a determination module (150) and a sensor module (160). The determination module (150) may include functionality to determine when at least one input object is in a sensing region, determine signal to noise ratio, determine positional information of an input object, determine a type of input object, perform other determinations, or a combination thereof.

The sensor module (160) may include functionality to drive the sensing elements to transmit transmitter signals and receive resulting signals. For example, the sensor module (160) may include sensory circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows only a determination module (150) and a sensor module (160), alternative or additional modules may exist in accordance with one or more embodiments of the invention. Such alternative or additional modules may correspond to distinct modules or sub-modules than one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures such as mode changing gestures, and mode changing modules for changing operation modes.

In some embodiments, the processing system (110) responds to user input (or lack of user input) in the sensing region (120) directly by causing one or more actions. Example actions include changing operation modes, as well as GUI actions such as cursor movement, selection, menu navigation, and other functions. In some embodiments, the processing system (110) provides information about the input (or lack of input) to some part of the electronic system (e.g. to a central processing system of the electronic system that is separate from the processing system (110), if such a separate central processing system exists). In some embodiments, some part of the electronic system processes information received from the processing system (110) to act on user input, such as to facilitate a full range of actions, including mode changing actions and GUI actions.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system (110).

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system (110)). Additionally, the embodiments of the present invention apply equally regardless of the particular type of medium used to carry out the distribution. For example, software instructions in the form of computer readable program code to perform embodiments of the invention may be stored, in whole or in part, temporarily or permanently, on a non-transitory computer readable storage medium. Examples of non-transitory, electronically readable media include various discs, physical memory, memory, memory sticks, memory cards, memory modules, and or any other computer readable storage medium. Electronically readable media may be based on flash, optical, magnetic, holographic, or any other storage technology.

Although not shown in FIG. 1, the processing system, the input device, and/or the host system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores, or micro-cores of a processor. Further, one or more elements of one or more embodiments may be located at a remote location and connected to the other elements over a network. Further, embodiments of the invention may be implemented on a distributed system having several nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

Turning to FIG. 2, FIG. 2 shows an example of absolute capacitance sensing when two input objects (e.g., finger 1 (202) and finger 2 (204)) are in the sensing region (120). Sensor electrodes are located along the x-axis (206) and y-axis (208). The sensor electrodes include transmitters and receivers. The receivers include functionality to receive resulting signals from the transmitters or to measure absolute capacitance. The absolute capacitance measured along an axis is used to generate a profile (e.g., x-axis profile (210), y-axis profile (212)). A profile (e.g., x-axis profile (210), y-axis profile (212)) can be viewed as a projection of the capacitance of the sensing region (120) along a particular axis. In other words, the x-axis profile (210) is the measured capacitance along the x-axis and the y-axis profile (212) is the measured capacitance along the y-axis. As shown in FIG. 2, because absolute capacitance sensing generates profiles of the sensing region (120), four different possible locations exist of the two fingers in the sensing region.

In one or more embodiments of the invention, the processing system, input device, and sensing region include functionality to perform both absolute capacitance sensing and trans capacitance sensing. FIG. 3 shows a diagram of the sensing region (120) with finger 1 (202) and finger 2 (204) in the sensing region when trans capacitance sensing is used. In trans capacitance sensing each transmitter (Tx) (e.g., Tx M (302), Tx N (304)) on one axis (e.g., the y-axis (208) in FIG. 3) transmits a signal and receivers (Rx) (e.g., Rx G (306), Rx H (308)) on the other axis (e.g., the x-axis (206) in FIG. 3) receive resulting signals. In one or more embodiments of the invention, trans capacitance sensing measures changes in capacitance between the transmitted signal and the resulting signal.

In one or more embodiments of the invention, the transmitters transmit one at a time in turn, thereby providing a scan of the sensing region (120). Receivers may receive resulting signals simultaneously. Because transmitters transmit one at a time, a separate capacitance measurement is taken for each intersection of a row and a column of the sensing region (120). In other words, rather than projected measurements, the value of each cell of the sensing region is measured.

As shown in example FIG. 3, when transmitter Tx M (302) transmits a signal, the lack of change in capacitance received at receiver Rx H (308) indicates that no object is located at the intersection of transmitter Tx M (302) and receiver Rx H (308). In contrast, the change in capacitance received at receiver Rx G (306) when transmitter Tx M (302) transmits the signal indicates a change in capacitance due to the arrival of an input object (e.g., finger 1 (202)), which is detected at location 1 (310). Also, as shown in example FIG. 3, when transmitter Tx N (304) transmits a signal, the lack of change in capacitance received at receiver Rx G (306) indicates that no object is located at the intersection of transmitter Tx N (304) and receiver Rx G (306). However, the change in capacitance received at receiver Rx H (308) when transmitter Tx N (304) transmits the signal indicates a change in capacitance and the arrival of an input object (e.g., finger 2 (204)) is detected at location 2 (312).

Next, consider the scenario in which at the time that transmitter Tx Q (314) is transmitting, a noise is injected into the sensing region (120) via finger 1 (202). Such noise may exist, for example, because of electrical noise present in the system which is injected by the input object. Because the noise is injected through finger 1 (202) when transmitter Tx Q (314) is transmitting, receiver Rx G (306) may erroneously detect an input object (e.g., a ghost finger) at location 3 (316). On the other hand, in absolute profile measurements, noise injected by the finger will be coincident with the profile locations of the fingers (i.e., the humps in the x axis profile (210) and the y axis profile (212)). The trans-cap ghost finger at location 3 (316) does not coincide with the profile positions of the fingers. Therefore, the ghost finger in the trans-cap sensing may be ruled-out by the profile along the transmitter axis. Because sensing region (120) includes functionality to perform both absolute capacitance and trans capacitance sensing, and the processing system includes functionality to detect ghost fingers based on the resulting signals of the absolute capacitance and trans capacitance sensing, such ghost fingers may be suppressed in reporting the location of the input object.

Although not discussed above, in some embodiments, some or all transmitters may transmit at overlapping times during trans capacitance sensing, such as by using code division multiplexing. In such a scenario, ghost fingers may occur based on the noise injected matching a particular transmitter.

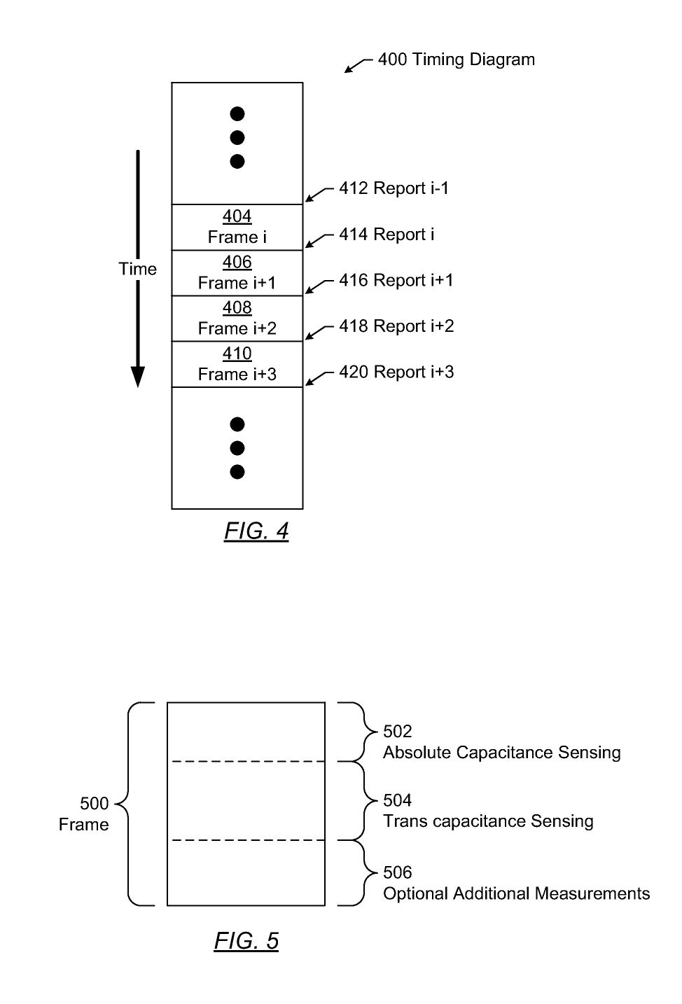

In one or more embodiments of the invention, the sensing region may be continuously or regularly monitored to identify the location of input objects. FIG. 4 shows a schematic timing diagram of monitoring the sensing region. As shown in FIG. 4, the monitoring of the sensing region may be partitioned into frames (e.g., frame i (404), frame i+1 (406), frame i+2 (408), frame i+3 (410)). The three collinear dots in FIG. 4 are used to show more frames may optionally exist before frame i (404) and after frame i+3 (410). Each frame represents a length of time to perform a single capture the state of the sensing region with respect to the existence of one or more input objects. In one or more embodiments of the invention, at the end of the frame, a report (e.g., report i−1 (412), report i (414), report i+1 (416), report i+2 (418), report i+3 (420)) may be transmitted to other components of the processing system, input device, host system, or other device, or combination thereof. Each report includes positional information (discussed above with reference to FIG. 1) regarding any input objects in the sensing region, with any detected ghost fingers suppressed.

Although FIG. 4 shows the report as being transmitted at the end of the frame and prior to the next frame, the report may be transmitted while the next frame is being performed. Further, although FIG. 4 shows frames as being equal size in terms of lengths of time, in some embodiments, frames may be different sizes as discussed below with reference to FIG. 5.

FIG. 5 shows a schematic diagram of a frame (500) in accordance with one or more embodiments of the invention. Specifically, FIG. 5 shows a schematic diagram of measurements that may be performed during a frame (500). As shown in FIG. 5, a frame (500) includes absolute capacitance sensing (502), trans capacitance sensing (504), and optional additional measurements (506). Although FIG. 5 shows a particular ordering between the absolute capacitance sensing (502), the trans capacitance sensing (504), and the optional additional measurements (506), the absolute capacitance sensing (502), trans capacitance sensing (504), and optional additional measurements (506) may be performed in any order. For example, the absolute capacitance sensing (502) may precede, succeed, or be performed at least in part at the same time as the trans capacitance sensing (504). Further, the optional additional measurements may similarly be performed at any time during the frame (500). In one or more embodiments of the invention, the combination of measurements may be made simultaneously. For instance, both axes can be measured either sequentially or simultaneously during the absolute capacitance sensing (502). Alternatively or additionally, the absolute capacitance sensing (502) and trans capacitance sensing (504) may instead be measured all at the same time.

In one or more embodiments of the invention, the result of the absolute capacitive sensing (502) is both an x-axis profile and a y-axis profile. In other words, transmitters and receivers on both axes may be used to obtain profile measurements on both axes. In one or more embodiments of the invention, the result of the absolute capacitance sensing may be to obtain a profile only on the same axis as the transmitters used for the trans capacitance sensing. If the transmitters used for trans capacitance sensing are on the x-axis, then the absolute capacitance sensing may be configured to obtain only an x-axis profile. Conversely, by way of another example, if the transmitters used for trans capacitance sensing are on the y-axis, then the absolute capacitance sensing may be configured to obtain only a y-axis profile.

In one or more embodiments of the invention, the result of the absolute capacitance sensing may be to identify a subset of the sensing region that has at least one detected input object. In other words, the measurements of the profile corresponding to the subset, adjusted for noise and a baseline, is greater than a threshold indicating the presence of at least one input object. The subset may or may not be internally connected. For example, if two input objects are in the sensing region and not next to each other, the subset may be the two separate regions in which the two input objects are detected or may correspond to the region defined by the maximum and minimum value of both input objects combined.

If the absolute capacitive sensing (502) precedes the trans capacitance sensing (504), the trans capacitance sensing (504) may be performed only for the subset in some embodiments of the invention. Thus, only the subset of the sensing region is scanned. Scanning only the subset of the sensing region may be performed by having only the transmitters corresponding to the subset transmit a signal. In such a scenario, the trans capacitance sensing may be performed at a changed duty cycle. The changed duty cycle may be an increase or a decrease in the duty cycle. In one or more embodiments of the invention, a different amount of time may be used to perform the trans capacitance sensing, a different number of measurements may be performed. By way of an example of increasing the duty cycle, the increased duty cycle may correspond to taking less time to perform the trans capacitance sensing for the frame, thereby reducing the length of time of the particular frame (i.e., reduce frame length time to perform more frames) and/or performing more optional additional measurements (506). Another possibility is to maintain the same frame (report) rate by spending more time measuring the subset of the sensing region indicated by the profile measurement. In this case, the signal-to-noise-and-interference may improve.

The optional additional measurements (506) may correspond to additional absolute capacitance measurements (502), trans capacitance measurements (504), or other measurements. For example, the optional additional measurements may be performed to obtain a higher signal to noise ratio, perform better filtering, or obtain multiple results to confirm identified location(s) of one or more input objects.

By scanning only a subset of the transmitters as determined by the presence of input objects in the absolute capacitance profile along the transmitter axis, the rest of the trans capacitive image can be set to a baseline value. Ghost fingers that might have appeared outside this subset of the transmitter regions are automatically suppressed since those transmitters are not scanned.

Although not shown in FIG. 5, as part of the frame (500) a report may be generated and transmitted. For example, the report may be generated while taking and analyzing the measurements.

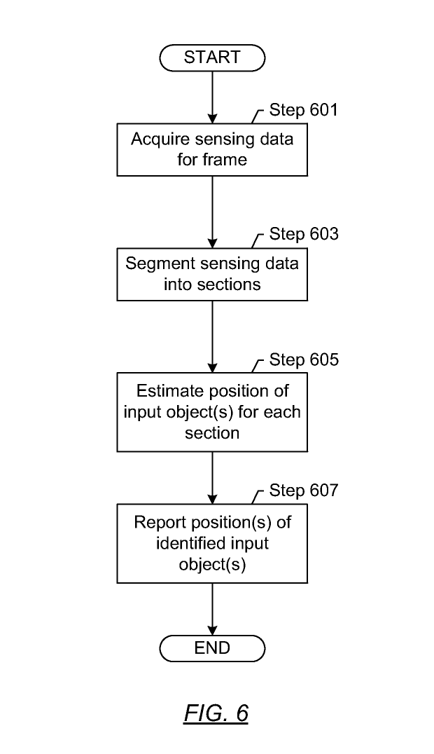

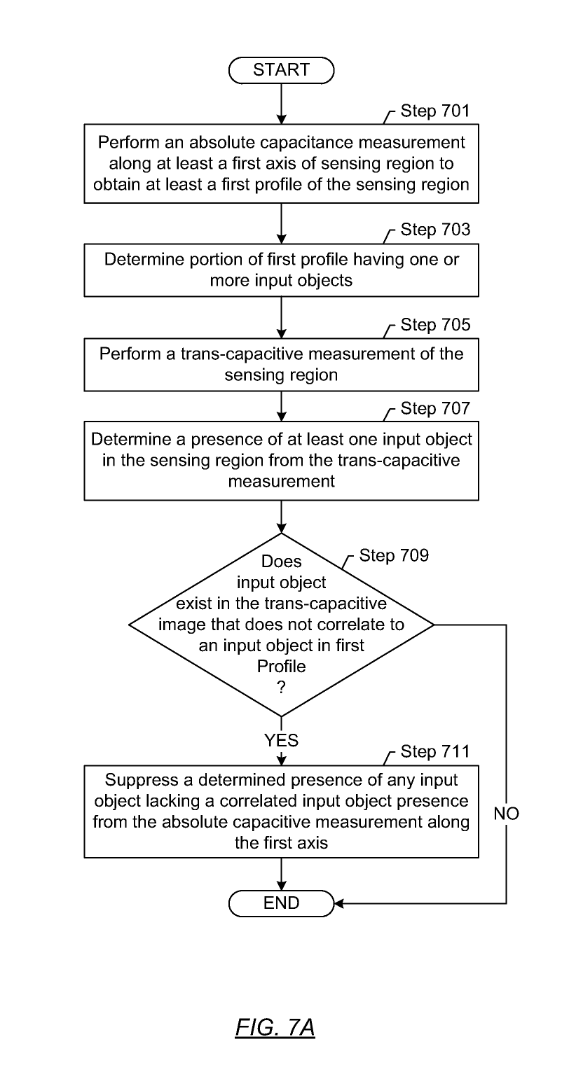

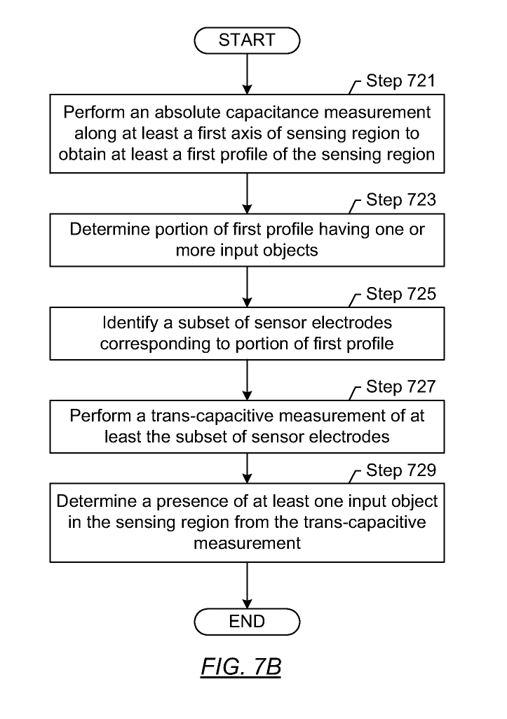

FIGS. 6, 7A, and 7B show flowcharts in accordance with one or more embodiments of the invention. While the various steps in these flowcharts are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that condition exists in accordance with one or more embodiments of the invention. As another example, determination steps may be performed by performing a test, such as checking a data value to test whether the value is consistent with the tested condition in accordance with one or more embodiments of the invention.

FIG. 6 shows a flowchart for detecting input objects in the sensing region in a frame in accordance with one or more embodiments of the invention. In Step 601, sensing data is obtained in accordance with one or more embodiments of the invention. Specifically, for absolute capacitance sensing, at least one profile is obtained. Obtaining a profile may include determining a measured data value corresponding to a resulting signal received with each sensor electrode. The resulting signals may be received at once or over a span of time. For example, the sensor electrodes may receive the resulting signals at one time and output the corresponding measured data values at one time. By way of another example, the sensor electrodes may receive resulting signals and output corresponding data row by row or column by column. Once the measured data values are determined, the measured data values may be grouped into the profile.

Further, for trans capacitance sensing, a trans capacitive image is obtained for the sensing region. In particular, the trans capacitive image may be obtained by the sensor module triggering each transmitter to transmit a signal at the same time, such as by using code division multiplexing, and/or in sequence. As discussed above, the obtained trans capacitive image may be for the entire sensing region or only for a subset of the sensing region.

Preprocessing may or may not be performed on the sensing data. For example, the sensing data may be temporally filtered, spatially filtered, or a combination thereof. Using the sensing data, a determination may be made whether one or more input objects are detected in the sensing region. The determination may be based on whether one or more measurements in the sensing region compensated for any noise satisfies a detection threshold.

Continuing with FIG. 6, in Step 603, the sensing data is segmented into sections. The segmenting includes partitioning the profile and/or trans capacitive image to represent individual contiguous regions, that each may have an input object. The partitioning is based on the measured data values with respect to surrounding measured data values.

For example, consider the scenario in which two input objects are in the sensing region, and an input object produces one or more high measured data values from a sensing electrode. In the example, because two input objects are in the sensing region, the measured data values include two regionally maximum values, each corresponding to an input object, separated in the ordered set by at least one smaller value (i.e., a local minimum). The segmenting of the sensing data may be based on the regional measured values, such that the two regionally maximum values of the profile or trans capacitive image are in individual sections.

In Step 605, the position of each input object is estimated in accordance with one or more embodiments of the invention. For example, for each section, a determination is made whether one or more input objects are in the section compensated for any noise satisfies a detection threshold.

In one or more embodiments of the invention, the profile is used to suppress ghost fingers in the trans capacitive image. Identifying detected input objects in the trans capacitive image as being ghost fingers may be performed at virtually any time during FIG. 6 in accordance with one or more embodiments of the invention. For example, at the data acquisition phase, the trans capacitive image may be acquired only on the subset of the sensing region in which the profile from the absolute capacitance sensing indicates the presence of an input object. By way of another example, at the segmentation phase, if the profile does not have a section corresponding to a section in the trans capacitive image, then the trans capacitive image section may be determined to have a ghost finger. By way of another example, at the calculating positional information stage, if the profile corresponding to the transmitters for the trans capacitive sensing does not show an input object that is in the trans capacitive image, then the input object in the trans capacitive image may be determined to be a ghost finger.

If an input object is detected for at least one section, positional information for input object(s) in the section(s) is calculated. In one or more embodiments of the invention, the positional information is calculated individually for each section. Calculating the positional information may include calculating a position of the input object along an axis or projected on the input surface and calculating a height of the input object. For example, the position may be interpolated using the positions surrounding the position of the sensor electrode producing a maximum value in the filtered profile for the segment (i.e., a local maximum). Alternatively, in various embodiments, the local minimum or other identifier may indicate the position.

Using the positional information, an action is performed based on the calculated positional information. The action may be to report the filtered positional information, such as to the host or a component of the host. In such a scenario, the host may perform one or more actions based on the positional information. The action may be to change the display of a graphical user interface (GUI), such a show that a cursor or pointer has move, show certain GUI component highlighted, perform an action defined by GUI component corresponding to the position (e.g., transition to another screen, make a phone call, or perform another GUI component defined action), or perform another action.

FIG. 7A shows a more detailed flowchart for ghost finger suppression in accordance with one or more embodiments of the invention. In Step 701, an absolute capacitance measurement is performed along at least a first axis of sensing region to obtain at least a first profile of the sensing region. In one or more embodiments, absolute capacitance sensing is performed to obtain a profile along the axis having the transmitters used for trans capacitance sensing. The absolute capacitance sensing may also optionally be performed to obtain a second profile along the second axis.

In Step 703 a portion of the first profile having one or more input objects is determined in accordance with one or more embodiments of the invention. Identifying the portion of the profile may be performed, for example, as discussed above with reference to Step 603 and 605 in FIG. 6.

Continuing with FIG. 7, in Step 705, a trans capacitive measurement is performed of the sensing region in accordance with one or more embodiments of the invention. In particular, the trans-capacitive measurement is performed on at least a subset of the sensor electrodes. In other words, the trans-capacitive image may be performed on the entire sensing region or only a subset of the sensing region in which the absolute capacitance measurement indicates the possibility of an input object. The sensor electrodes transmits signals, which results in the receiving sensor electrodes receiving a resulting signal. From the trans capacitive measurements for the subset, a trans capacitive image is generated of the sensing region.

In Step 707, a presence of at least one input object in the sensing region from the trans capacitive measurement is determined in accordance with one or more embodiments of the invention. In particular, at least a portion of the trans capacitive image satisfying a detection threshold indicating a presence of at least one input object is determined.

In Step 709, a determination is made whether an input object exists in the trans capacitive image that does not correlate to an input object in the first profile in accordance with one or more embodiments of the invention. In particular, a determination is made whether the any input object is detected in the trans capacitive image that was not detected using absolute capacitance sensing. Such input object that is not in the profile from the absolute capacitance sensing and in the trans-capacitive image may be determined to be a ghost finger.

In Step 711, a determined presence of any input object lacking a correlated input object presence from the absolute capacitive measurement along the first axis is suppressed in accordance with one or more embodiments of the invention. The suppression of the ghost fingers may be performed by suppressing the detected ghost finger(s) in the report. Suppressing the ghost finger(s) in the report may include not reporting the location in which a ghost finger is detected and/or including an alert that a ghost finger was detected during the corresponding frame. For example, the alert may be a flag or other signal indicating that the input object is a ghost finger.

Although FIG. 7A shows the absolute capacitance sensing being performed before the trans-capacitance sensing, the absolute capacitance sensing may be performed during or after the trans-capacitance sensing without departing from the scope of the invention.

FIG. 7B shows another flowchart for ghost finger suppression in accordance with one or more embodiments of the invention. In particular, FIG. 7B shows a flowchart for ghost finger suppression by performing trans-capacitance sensing only on portions of the sensing region in which an input object is detected using the absolute capacitance sensing. In FIG. 7B, Steps 721, 723, 727, and 729 may be performed in the same or similar manner as discussed above with reference to Steps 701, 703, 705, and 707, respectively, in FIG. 7A.

In Step 721 of FIG. 7B, an absolute capacitance measurement is performed along at least a first axis of sensing region to obtain at least a first profile of the sensing region. In Step 723, a portion of the first profile having one or more input objects is determined in accordance with one or more embodiments of the invention.

In Step 725, a subset of sensor electrodes corresponding to the portion of the first profile is identified in accordance with one or more embodiments of the invention. In particular, one or more locations along the first axis corresponding to the identified portion of the profile are determined. The subset of sensor electrodes used for trans capacitance that are at the determined location is selected.

In Step 727, a trans capacitive measurement is performed of at least the subset of sensor electrodes in accordance with one or more embodiments of the invention. In particular, the trans-capacitive measurement is performed only on the portion of the sensing region in which the absolute capacitance measurement is taken. Thus, any ghost fingers are suppressed by not scanning portions of the sensing region which may have a ghost finger.

In Step 729, a presence of at least one input object in the sensing region from the trans capacitive measurement is determined in accordance with one or more embodiments of the invention. At this stage, a report may be generated and presented that includes the at least one input object.

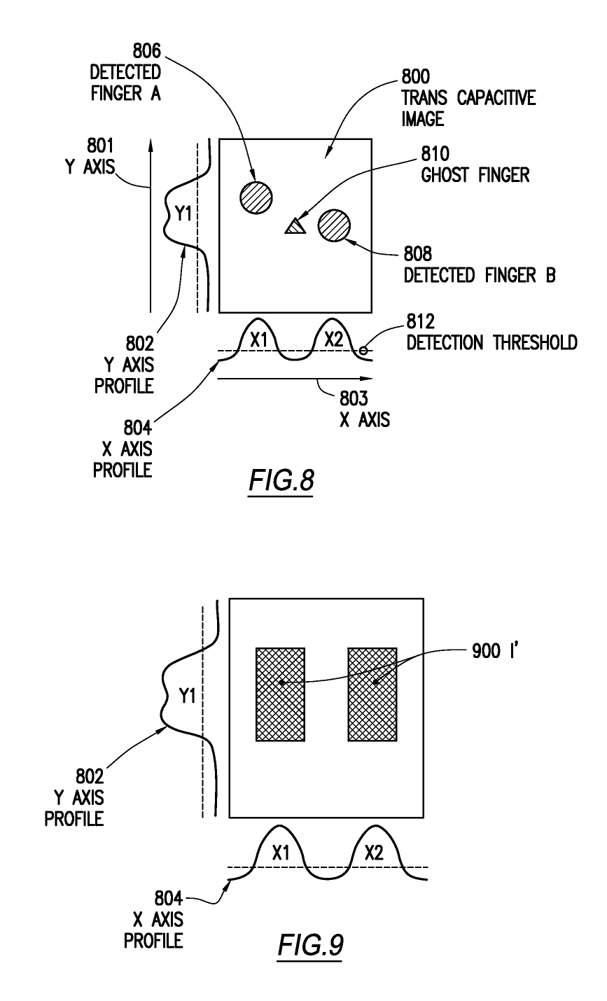

FIGS. 8 and 9 show an example in accordance with one or more embodiments of the invention. The following example is for explanatory purposes only and not intended to limit the scope of the invention. For example, although the examples in the present application are directed to two input objects, similar techniques as described herein may be performed when fewer or more input objects are detected in the sensing region.

FIG. 8 shows a trans capacitive image (800) and profiles from absolute capacitance sensing (e.g., Y axis profile (802), X axis profile (804)) using a hybrid capacitive sensor with two fingers place on the sensor. The Y axis (801) corresponds to receivers for the trans capacitance sensing and the X axis (803) corresponds to transmitters for the trans capacitance sensing.

As shown in FIG. 8, based on the trans capacitive image (800), detected finger A (806), detected finger B (808), and a ghost finger (810) exists in the trans capacitive image. Although not shown in FIG. 8, the ghost finger (810) is not distinguishable from any other finger in the trans capacitive image (800). The ghost finger (810) exists in the trans capacitive image due to finger coupled noise from finger B. In particular, because the transmitters in a trans capacitive sensor are scanned, that noise spike through finger B occurred at a different time than when the finger B was scanned. Thus, the receiver on the row having finger B detects the spike indicating a presence of a finger at the time that the transmitter on the column of the ghost finger sends a signal. Because of the timing, a finger is detected, albeit ghost finger (810). When the Y axis profile (802) and X axis profile (804) are obtained, noise spikes are only coupled into electrodes the finger is covering and do not show on other rows or columns.

Continuing with the example, if I represents the set of all pixels in the sensor, define

$${I}^{′} = \{ ( x , y ) ∈ I \vert ( x , y ) ∈ {⋃}_{i , j} {X}^{i} ⋂ {Y}^{j} \} \qquad ( 1 )$$

where Xⁱ and Y^{j} are the x and y electrodes, respectively, corresponding to finger touch locations that exceed a profile detection threshold (812).

FIG. 9 shows the set I′ (900) corresponding to the finger touch locations detected in the absolute capacitance sensing from the Y axis profile (802) and X axis profile (804) shown in FIG. 8. As shown in FIG. 9, the noise spike shown in FIG. 8 is not included in the set I′ (900).

Let P_{i,j}=X′∩Y^{j} represent the feasible finger locations as determined by the Y axis profile (802) and X axis profile (804). The finger locations may be referred to as “candidate finger locations” or I′ (900). Any trans capacitive finger, which is not located in a candidate finger location, may be excluded as a ghost finger. Because the noise spike location corresponding to ghost finger (810) is not in a candidate finger location, the noise spike location is determined to be a ghost finger and suppressed. The feasible finger locations may also be determined by identifying the union of possible finger locations as determined by only the transmitter axis.

Continuing with the example, let (x,y)ₜᵣₐₙₛ be the position estimate for a trans capacitive image blob segment having a finger. Let (x,y)_{abs} be the position estimate for the P_{i,j} in which (x,y)ₜᵣₐₙₛεP_{i,j}. In other words, (x,y)_{abs} corresponds to the set of finger locations detected by the absolute capacitive sensing that are also in the trans capacitive sensing. In the presence of noise, improved finger position estimate (higher accuracy, less jitter) may be obtained by using (x,y)_{abs} as the position estimate of the fingers or by using a linear or nonlinear combination of (x,y)_{abs} and (x)ₜᵣₐₙₛ as the position estimate.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A processing system for a capacitive input device, the capacitive input device comprising an array of sensor electrodes configured to sense input objects in a sensing region of the input device, the processing system comprising functionality to:
perform a trans capacitance measurement of the array of sensor electrodes;
determine a presence of at least one input object in the sensing region from the trans capacitance measurement;
perform an absolute capacitive measurement along a first axis of the array of sensor electrodes; and
suppress the determined presence of at least one input object based on a lack of a correlated input object presence from the absolute capacitive measurement along the first axis.

2. The processing system of claim 1, further comprising functionality to:
perform an absolute capacitive measurement along a second axis of the array of sensor electrodes,
wherein the determined presence of at least one input object is further suppressed based on a lack of a correlated input object presence from the absolute capacitive measurement along the second axis.

3. The processing system of claim 1, further comprising functionality to:
determine a portion of the first profile having at least one input object; and
identify a first subset of sensor electrodes in the sensing region corresponding to the portion,
wherein performing the absolute capacitive measurement is prior to performing the trans capacitance measurement, and
wherein the performing the trans capacitance measurement is only on the first subset of sensor electrodes.

4. The processing system of claim 3, wherein performing the trans capacitance measurement only on the subset is at a changed duty cycle.

5. The processing system of claim 3, wherein, for at least two different frames, the performing of the trans capacitance measurement is on different subsets of sensor electrodes based on an absolute capacitive measurement for each of the at least two different frames.

6. The processing system of claim 1, wherein the first axis corresponds to electrodes configured to transmit a transmitter signal during the trans capacitance measurement.

7. The processing system of claim 1, wherein suppressing the determined presence of the at least one input object is performed by omitting the at least one input object in a report of input objects in the sensing region.

8. The processing system of claim 1, wherein suppressing the determined presence of the at least one input object is performed by including an alert for the at least one input object in a report of input objects in the sensing region.

9. A method comprising:
performing a trans capacitance measurement of an array of sensor electrodes configured to sense input objects in a sensing region of the input device;
determining a presence of at least one input object in the sensing region from the trans capacitance measurement;
performing an absolute capacitive measurement along a first axis of the array of sensor electrodes; and
suppressing the determined presence of at least one input object based on a lack of a correlated input object presence from the absolute capacitive measurement along the first axis.

10. The method of claim 9, further comprising:
performing an absolute capacitive measurement along a second axis of the array of sensor electrodes,
wherein the determined presence of at least one input object is further suppressed based on a lack of a correlated input object presence from the absolute capacitive measurement along the second axis.

11. The method of claim 9, further comprising:
determining a portion of the first profile having at least one input object; and
identifying a first subset of sensor electrodes in the sensing region corresponding to the portion,
wherein performing the absolute capacitive measurement is prior to performing the trans capacitance measurement, and
wherein the performing the trans capacitance measurement is only on the first subset of sensor electrodes.

12. The method of claim 11, wherein performing the trans capacitance measurement only on the subset is at a changed duty cycle.

13. The method of claim 9, wherein the first axis corresponds to electrodes configured to transmit a transmitter signal during the trans capacitance measurement.

14. The method of claim 9, further comprising:
generating a report of input objects in the sensing region, wherein suppressing the determined presence of the at least one input object is performed by omitting the at least one input object in the report.

15. The method of claim 9, further comprising:
generating a report of input objects in the sensing region, wherein suppressing the determined presence of the at least one input object is performed by including an alert for the at least one input object in the report.

16. An input device comprising:
an array of sensor electrodes configured to sense input objects in a sensing region of the input device; and
a processing system configured to:
perform a trans capacitance measurement of the array of sensor electrodes;
determine a presence of at least one input object in the sensing region from the trans capacitance measurement;
perform an absolute capacitive measurement along a first axis of the array of sensor electrodes; and
suppress the determined presence of at least one input object based on a lack of a correlated input object presence from the absolute capacitive measurement along the first axis.

17. The input device of claim 16, wherein the processing system is further configured to:
perform an absolute capacitive measurement along a second axis of the array of sensor electrodes,
wherein the determined presence of at least one input object is further suppressed based on a lack of a correlated input object presence from the absolute capacitive measurement along the second axis.

18. The input device of claim 16, wherein the processing system is further configured to:
determining a portion of the first profile having at least one input object; and
identifying a first subset of sensor electrodes in the sensing region corresponding to the portion,
wherein performing the absolute capacitive measurement is prior to performing the trans capacitance measurement, and
wherein the performing the trans capacitance measurement is only on the first subset of sensor electrodes.

19. The input device of claim 18, wherein performing the trans capacitance measurement only on the subset is at a changed duty cycle.

20. The input device of claim 16, wherein the first axis corresponds to electrodes configured to transmit a transmitter signal during the trans capacitance measurement.
